(19) United States
(12) Patent Application Publication
(10) Pub. No.: US 2024/0248273 A1
(43) Pub. Date: Jul. 25, 2024

(54) CABLE ADAPTER TRAY WITH SPLIT CABLE ROUTING CHANNEL CONFIGURED TO ENHANCE CABLE MANAGEMENT

(71) Applicant: PPC BROADBAND, INC., East Syracuse, NY (US)

(72) Inventors: Harvey ETHERIDGE, Norfolk (GB); Shaun TREZISE, Aldeburgh (GB)

(73) Assignee: PPC BROADBAND, INC., East Syracuse, NY (US)

(21) Appl. No.: 18/422,146

(22) Filed: Jan. 25, 2024

Related U.S. Application Data
(60) Provisional application No. 63/441,101, filed on Jan. 25, 2023.

(51) Int. Cl. G02B 6/44; H04Q 1/02

(52) U.S. Cl. CPC G02B 6/44528; G02B 6/445; H04Q 1/09; H04Q 2201/08; H04Q 2201/10; H04Q 2201/804

(57) ABSTRACT

An adapter management device configured to provide enhanced cable management that may include an adapter receiving portion, a perimeter portion, an inner cable retention portion, which may be configured to be positioned between the perimeter portion and the adapter receiving portion. and a cable receiving portion separator portion that may be configured to extend between the perimeter portion and the inner cable retention portion. The cable receiving portion separator portion may be structurally configured to provide a first cable routing path and a second cable routing path so as to enhance organization of cables in the adapter management device by providing two separate routing options for routing cables in the adapter management device.

### CROSS-REFERENCE TO RELATED APPLICATION

This application claims the benefit of U.S. Provisional Application No. 63/441,101 filed Jan. 25, 2023, which is currently pending, the disclosure of which is hereby incorporated by reference herein in its entirety.

### BACKGROUND

The present disclosure relates to fiber management and, more particularly, to connector adapter trays.

In typical adaptor trays, connectors can be challenging to unlatch as the housing cannot easily be gripped. The tray can only be accessed from one side which may cause difficulties in some installations. Current adaptor trays have a ‘floor’ that prevents gripping the connector from above/below, and also prevents access from one side.

Conventionally, fiber trays route fibers across the tops of trays which limits access and flexibility when used with other components. When a large number of fibers are involved, the tray can get messy and difficult to organize. In tight spaces, it can be difficult to access the side of the tray where the fibers are routed.

In some enclosures or other tray mounting arrangements, a plurality of trays are positioned in a stacked arrangement where an upper tray must be moved to access a lower tray. In such arrangements, a technician must hold the upper tray in a position that allows access to the lower tray while the technician works with/on the lower tray. This requirement can impede efficient work.

It may be desirable to provide a tray that has an open area that is configured to permit simultaneous access to a first side of a cable connector that faces a same direction as a first side of the adapter tray and a second side of the cable connector that faces a same direction as a second side of the adapter tray so as to facilitate connecting the connector to and disconnecting the connector from the adapter.

It may be desirable to provide a channel configured to fibers through a fiber management tray. In embodiments, the channel can include an intersecting rib to separate the channel into a top and bottom half. The tray routing can enable fibers to be routed through both sections of the channel to separate different fiber groups going to either side of the adaptor tray, or to separate fibers going to different splice trays.

It may be desirable to provide a mechanism that holds an upper tray, or trays, in an open or upper position that allows access to trays below the upper tray without requiring the technician to hold, or otherwise prop, the upper tray in the open or upper position.

### SUMMARY

In embodiments, an upper cable receiving portion may be configured to provide a first cable routing path along a first side of the cable adapter tray and a lower cable receiving portion may be configured to provide a second cable routing path along an opposite second side of a cable adapter tray so as to enhance organization of cables in the cable adapter tray by providing two separate routing options for routing cables in the cable adapter tray.

Embodiments provide a cable adapter tray configured to provide enhanced cable management, including: an adapter mounting portion that may be configured to receive an optical fiber cable adapter that may be configured to receive a cable connector attached to a cable; a perimeter portion that may be configured to extend around the adapter mounting portion; an inner cable retention portion that may be configured to be positioned between the perimeter portion and the adapter mounting portion; and a cable receiving portion separator portion that may be configured to extend between the perimeter portion and the inner cable retention portion. The cable receiving portion separator portion may be configured to separate an area between the perimeter portion and the inner cable retention portion into an upper cable receiving portion and a lower cable receiving portion. The upper cable receiving portion may be configured to receive and retain one or more first cables. The lower cable receiving portion may be configured to receive and retain one or more second cables. The upper cable receiving portion may be structurally configured to provide a first cable routing path along a first side of the cable adapter tray and the lower cable receiving portion may be structurally configured to provide a second cable routing path along an opposite second side of the cable adapter tray so as to enhance organization of cables in the cable adapter tray by providing two separate routing options for routing cables in the cable adapter tray.

In particular embodiments, the upper cable receiving portion may be a channel, and the lower cable receiving portion may be a channel.

In particular embodiments, the adapter tray includes a hinge portion that may be configured to be pivotally coupled with a receiving portion of a base portion such that the cable adapter tray may be configured to pivot between an open position and a closed position.

In particular embodiments, the cable adapter tray may further comprise an upper cable receiving portion cable retaining portion that may be configured to extend between the perimeter portion and the inner cable retention portion and over the upper cable receiving portion.

In particular embodiments, the upper cable receiving portion cable retaining portion may comprise an upper cable receiving portion access opening.

In particular embodiments, the upper cable receiving portion access opening may be configured to allow a cable to be inserted into the upper cable receiving portion.

In particular embodiments, the cable adapter tray may further comprise a lower cable receiving portion cable retaining portion that may be configured to extend between the perimeter portion and the inner cable retention portion and over the lower cable receiving portion, the lower cable channel receiving portion retaining portion may comprise a lower cable receiving portion access opening that may be configured to allow a cable to be inserted into the lower cable receiving portion.

In particular embodiments, the cable adapter tray may further comprise a lower cable receiving portion cable retaining portion that may be configured to extend between the perimeter portion and the inner cable retention portion and over the lower cable receiving portion, and the lower cable receiving portion cable retaining portion may comprise a lower cable receiving portion access opening.

In particular embodiments, the cable adapter tray may further comprise a lower cable receiving portion cable retaining portion that may be configured to extend between the perimeter portion and the inner cable retention portion and over the lower cable receiving portion.

In particular embodiments, the inner cable retention portion may be parallel to the perimeter portion at a majority of locations of the inner cable retention portion.

In particular embodiments, the inner cable retention portion may be parallel to the perimeter portion at all locations of the inner cable retention portion.

Embodiments provide an adapter management device configured to provide enhanced cable management, including: an adapter receiving portion; a perimeter portion; an inner cable retention portion that may be configured to be positioned between the perimeter portion and the adapter receiving portion; and a cable receiving portion separator portion that may be configured to extend between the perimeter portion and the inner cable retention portion and separate an area between the perimeter portion and the inner cable retention portion into a first cable receiving portion and a second cable receiving portion. The first cable receiving portion may be configured to receive and retain one or more first cables. The second cable receiving portion may be configured to receive and retain one or more second cables. The first cable receiving portion may be structurally configured to provide a first cable routing path along a first side of the adapter management device and the second cable receiving portion may be structurally configured to provide a second cable routing path along an opposite second side of the adapter management device so as to enhance organization of cables in the adapter management device by providing two separate routing options for routing cables in the adapter management device.

In particular embodiments, the upper cable receiving portion may be a channel, and the lower cable receiving portion may be a channel.

In particular embodiments, the adapter receiving portion may be configured to receive an optical fiber cable adapter that may be configured to receive a cable connector attached to a cable.

In particular embodiments, the perimeter portion may be configured to extend around the adapter receiving portion.

In particular embodiments, the adapter management device may include a hinge portion that may be configured to be pivotally coupled with a receiving portion of a base portion such that the adapter management device may be configured to pivot between an open position and a closed position.

In particular embodiments, the adapter management device may further comprise a first cable receiving portion cable retaining portion that may be configured to extend between the perimeter portion and the inner cable retention portion and over the first cable receiving portion.

In particular embodiments, the first cable receiving portion cable retaining portion may comprise a first cable receiving portion access opening.

In particular embodiments, the first cable receiving portion access opening may be configured to allow a cable to be inserted into the first cable receiving portion.

In particular embodiments, the adapter management device may further comprise a second cable receiving portion cable retaining portion that may be configured to extend between the perimeter portion and the inner cable retention portion and over the second cable receiving portion, and the second cable receiving portion cable retaining portion may comprise a lower cable receiving portion access opening.

In particular embodiments, the adapter management device may further comprise a second cable receiving portion cable retaining portion that may be configured to extend between the perimeter portion and the inner cable retention portion and over the second cable receiving portion.

In particular embodiments, the inner cable retention portion may be parallel to the perimeter portion at a majority of locations of the inner cable retention portion.

Embodiments provide an adapter management device, including: an adapter receiving portion; a perimeter portion; an inner cable retention portion that may be configured to be positioned between the perimeter portion and the adapter receiving portion; and a cable receiving portion separator portion that may be configured to extend between at least a portion of the perimeter portion and the inner cable retention portion. The cable receiving portion separator portion is structurally configured to provide a first cable routing path and a second cable routing path so as to enhance organization of cables in the adapter management device by providing two separate routing options for routing cables in the adapter management device.

In particular embodiments, the first cable routing path may be a channel, and the second cable routing path may be a channel.

In particular embodiments, the cable receiving portion separator portion may be configured to extend between the perimeter portion and the inner cable retention portion and separate an area between the perimeter portion and the inner cable retention portion into the first cable routing path and the second cable routing path.

In particular embodiments, the first cable routing path may be a first cable receiving portion and the second cable routing path may be a second cable receiving portion.

In particular embodiments, the first cable receiving portion may be configured to receive and retain one or more first cables, and the second cable receiving portion may be configured to receive and retain one or more second cables.

In particular embodiments, the adapter management device may further comprise a first cable receiving portion cable retaining portion that may be configured to extend between the perimeter portion and the inner cable retention portion and over the first cable receiving portion.

In particular embodiments, the first cable receiving portion cable retaining portion may comprise a first cable receiving portion access opening that may be configured to allow a cable to be inserted into the first cable receiving portion

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a front view of a generic fiber-to-the-home fiber optic distribution box having a solid adapter tray populated with connectors;

FIG. 2 is a perspective view of an exemplary adapter tray mounted for accessibility in accordance with various aspects of the disclosure;

FIG. 3 is perspective view of the exemplary adapter tray shown in FIG. 2;

FIG. 4 is a plan view of the exemplary adapter tray shown in FIG. 2;

FIG. 5 is a plan view of the exemplary adapter tray shown in FIG. 2 mounted in a distribution box and populated with connectors in accordance with various aspects of the disclosure;

FIG. 6 is a perspective view of the exemplary adapter tray shown in FIG. 2;

FIG. 7 is a perspective view of a mounted exemplary adapter tray configured to receive a double layer of adapters;

FIG. 8 is a perspective view of the example shown in FIG. 7 with the adapter tray and splice trays in open positions;

FIG. 9 is a perspective view of the exemplary adapter tray shown in FIG. 7;

FIG. 10 is a sectional view of the example shown in FIG. 7;

FIG. 11 is a perspective view of the example shown in FIG. 7 showing exemplary transport tubes in accordance with various aspects of the disclosure;

FIG. 12 is a partial perspective view of the example shown in FIG. 11;

FIG. 13 is a side view of an exemplary adapter tray having an exemplary adapter tray clip in accordance with various aspects of the disclosure;

FIG. 14 is a side view of the adapter tray shown in FIG. 13 with the adapter tray in an unclipped position;

FIG. 15 is a partial perspective view of the adapter tray shown in FIG. 13 in a clipped position;

FIG. 16 is a partial bottom view of the adapter tray shown in FIG. 13;

FIG. 17 is a plan view of an exemplary base plate in accordance with various aspects of the disclosure; and

FIG. 18 is a perspective view of the base plate of FIG. 17 and the adapter tray of FIG. 13 in a clipped position.

### DETAILED DESCRIPTION

In embodiments, an upper cable receiving portion may be structurally configured to provide a first cable routing path along a first side of the cable adapter tray and a lower cable receiving portion may be structurally configured to provide a second cable routing path along an opposite second side of a cable adapter tray so as to enhance organization of cables in the cable adapter tray by providing two separate routing options for routing cables in the cable adapter tray.

In embodiments of the disclosure, an upper cable channel is configured to provide a first cable routing path along a first side of an adapter tray and a lower cable channel is configured to provide a second cable routing path along an opposite second side of the adapter tray so as to provide two separate routing options for routing a cable from an adapter in the adapter tray.

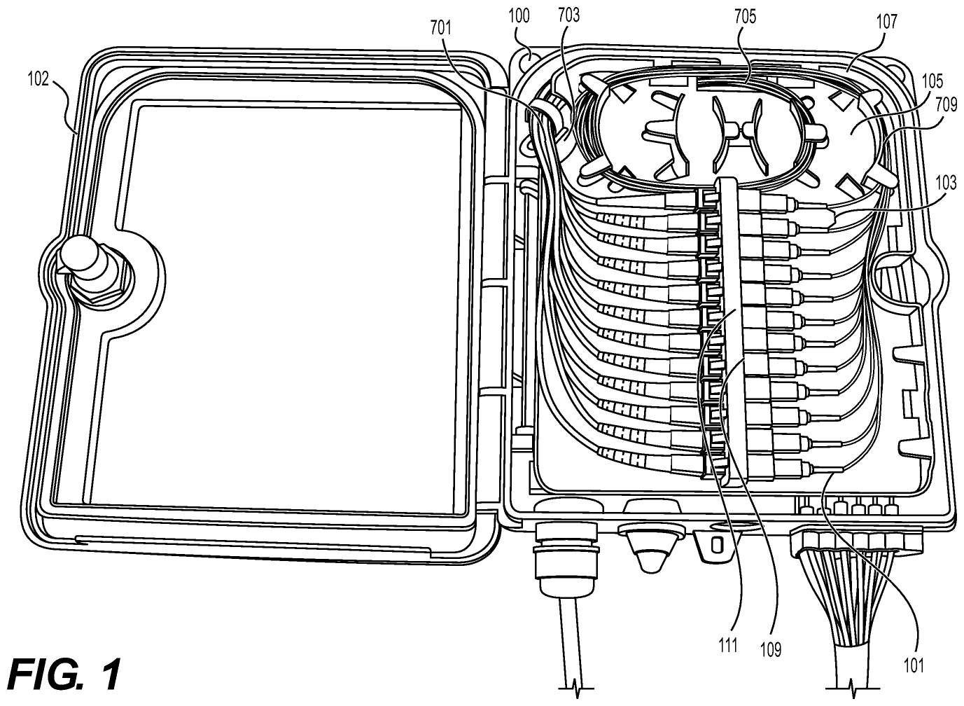

FIG. 1 shows is a generic fiber-to-the-home distribution box 100. The generic distribution box 100 includes an adapter tray 107 and cover 102. The adapter tray 107 includes a connector mounting housing 109 and a rib 111. In this example, a plurality of connectors 101 and attached cables 103 are individually mounted in the connector mounting housing 109. The adapter tray 107 includes is a floor 105 which is adjacent to the connectors 101. The available space for manipulating the connectors 101 is limited to the distance between the connectors 101 and/or the cables 103 and the adaptor tray floor 105. The connectors 101 can be difficult to connect and/or disconnect in high density adaptor trays 107 due to the lack of space around each of the connectors 101. This is particularly true for the connectors 101 at the edges of the tray 107 or between other of the connectors 101. There is little space to grip an individual connector 101 due to the high density setup and the adapter tray floor 105.

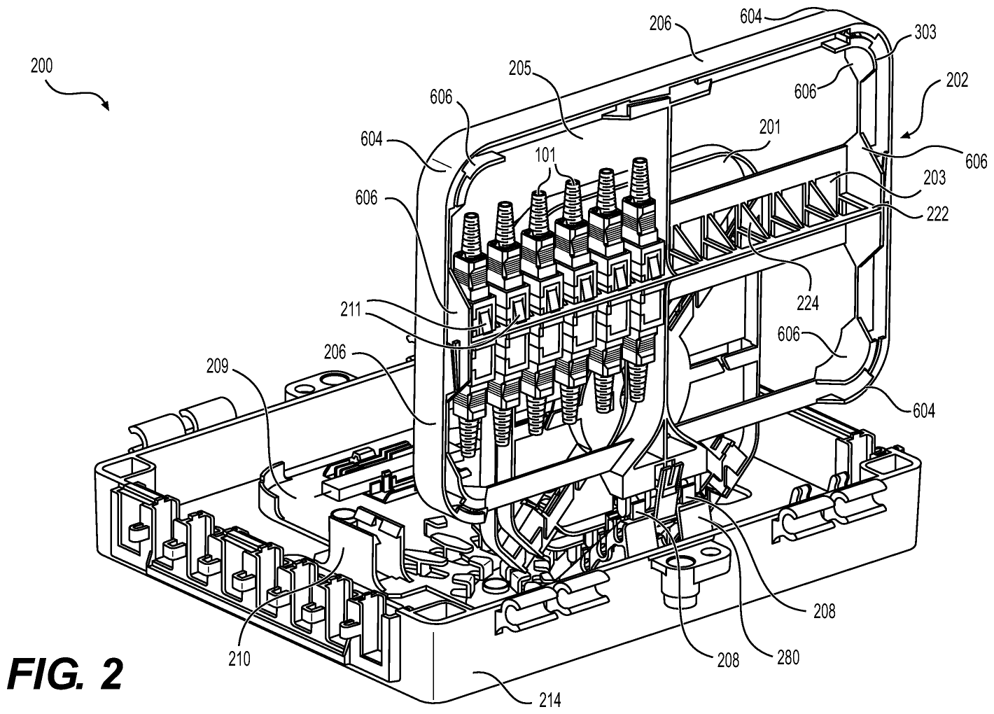

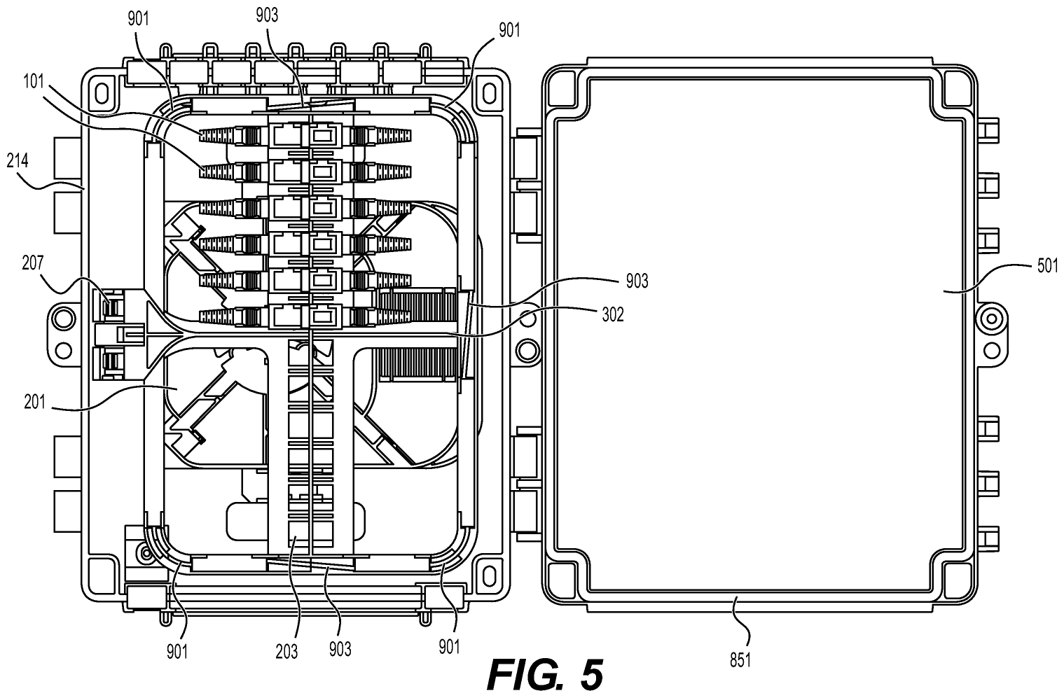

FIG. 2 shows an exemplary distribution box 200 in accordance with aspects of the disclosure. In this example, the distribution box 200 includes an adapter management device, for example, an adapter tray, 202, two splice trays 201, a base portion, for example, a base structure, for example, a base plate/splitter tray, 209, and an enclosure 214. FIG. 2 shows a top side of the adapter tray 202. An adapter receiving portion, for example, an adapter mounting portion, for example, an adapter receiving fence, 222 extends from the top side of the adapter tray 202 and is configured to receive a plurality of adapters 211. In embodiments, each adapter 211 is configured to receive one or more connectors 101. The open design of the adapter tray 202 (described in more detail below) allows a user to pinch the connectors 101 from both sides, which is not possible when using adapter trays such as the adaptor tray depicted in FIG. 1. The adapter tray 202 is configured to clip into one or more receiving portions 208 of the base plate 209 such that the adapter tray 202 is rotatable relative to the base plate 209. In this example, the adapter tray 202 has two hinge portions, for example, hinge pins, 207 that each snap into one of the receiving portions 208 and the adapter tray 202 rotates or pivots between an open position shown in FIG. 2 and a closed position shown, for example, in FIG. 5. In embodiments, the adapter tray 202 pivots independently from the splice trays 201. When the adapter tray 202 is in the closed position (pivoted toward the base plate 209), as shown in FIG. 5, for example, one or more securing features 210 secure the adapter tray 202 to the base plate 209. In this example, by securing the adapter tray 202 to the base plate 209, the securing features 210 also keep the splice trays 201 in a closed position due to the splice trays 201 being located between the base plate 209 and the adapter tray 202. While the examples shown include two hinges (or hinge pins 207), other examples have one hinge or more than two hinges located centrally and/or at additional locations spaced away from the central area of the edge of the adapter tray 202. Additional hinges and/or locations can be configured to resist twisting of the adapter tray 202 when it is pivoted relative to the base plate 209.

In the example shown in FIG. 2, separating walls 224 separate the fence 222 into individual openings 203 that are each configured to receive one of the adapters 211. As shown in FIG. 2, the adapter tray 202 has a plurality of open areas 205 within a perimeter portion, for example, a perimeter wall, 206. The open areas 205 provide access by a user to both sides of the connectors 101 when the adapter tray 202 is in the open position shown in FIG. 2. This access allows a user to grasp the connectors 101 from two opposite sides to more easily pinch the connector 101 and disconnect the connector 101 from its associated adapter 211. Similarly, this two-sided access allows a user to grasp the adapters 211 from two opposite sides to more easily pinch the adapter 211 and disconnect the adapter 211 from the fence 222.

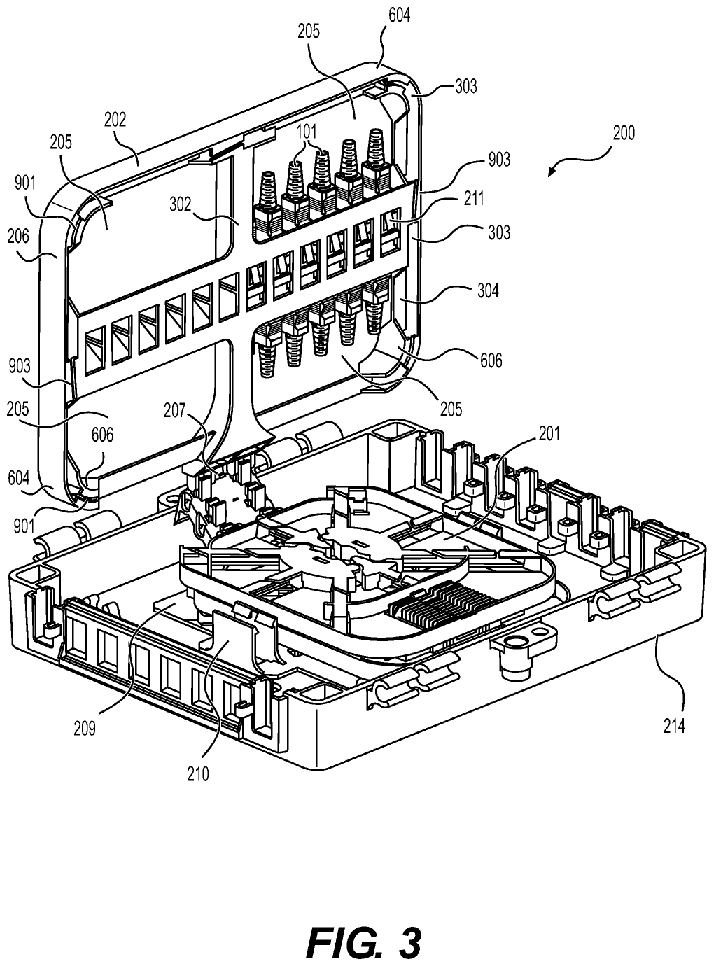

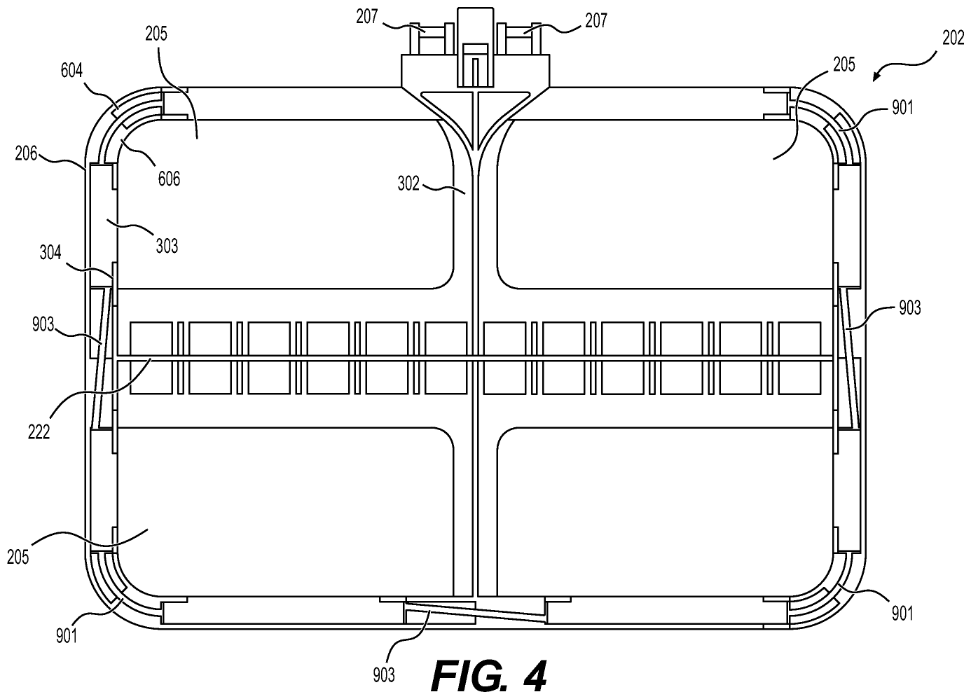

FIG. 3 is an underside view of the adaptor tray 202 and FIG. 4 is a plan view of the adapter tray 202. FIG. 5 is a top view of the enclosure 214 with the adapter tray 202 in a closed position. in the example shown in FIG. 3, the adapter tray 202 has four of the open areas 205. Other examples have fewer or more of the open areas 205. When the splice trays 201 are rotated to the closed position shown in FIG. 3, the user can take advantage of unobstructed access to the connectors 101 and the adapters 211 provided by the open areas 205. This unobstructed access allows the connectors 101 and/or the adapters 211 to be located close to, or even touching, each other because no space between the connectors 101 and/or the adapters 211 is needed for gripping the connectors 101 and/or the adapters 211. In embodiments, the perimeter wall 206 and one or more inner walls 304 form a cable receiving portion, for example, a cable channel, 303 around the open areas 205. In embodiments, the cable channel 303 has a plurality of openings that allow cables to enter and exit the cable channel 303 at various locations.

In embodiments, a cable receiving portion separator portion that is configured to extend between the perimeter wall and the inner cable retention portion. The cable receiving portion separator portion is configured to separate an area between the perimeter wall and the inner cable retention portion into an upper or first cable receiving portion, for example, an upper or first cable channel, and a lower or second cable receiving portion, for example, a lower or second cable channel. The upper cable channel is configured to receive and retain one or more first cables, and the second cable channel is configured to receive and retain one or more second cables.

FIG. 3 shows the adapter tray 202 including a support portion, for example, a beam, 302 that provides structure to support the perimeter wall 206 and the fence 222. In embodiments, the perimeter wall 206, the inner wall 304, the beam 302, and the fence 222 are formed as a single component, enabling efficient manufacturing options such as, for example, 3D printing. In embodiments, one or more of the perimeter wall 206, the inner wall 304, the beam 302, and the fence 222 is formed as a separate part.

FIG. 4 shows the upper side of the adapter tray 202 and shows the cable channel 303 formed by the permitter wall 206 and the inner walls 304. FIG. 5 shows the adapter tray 202 in the closed position in the enclosure 214. In this closed position, the adapter tray 202 is positioned above the splice trays 201. Also shown in FIG. 5 is a cover 501 of the enclosure 214.

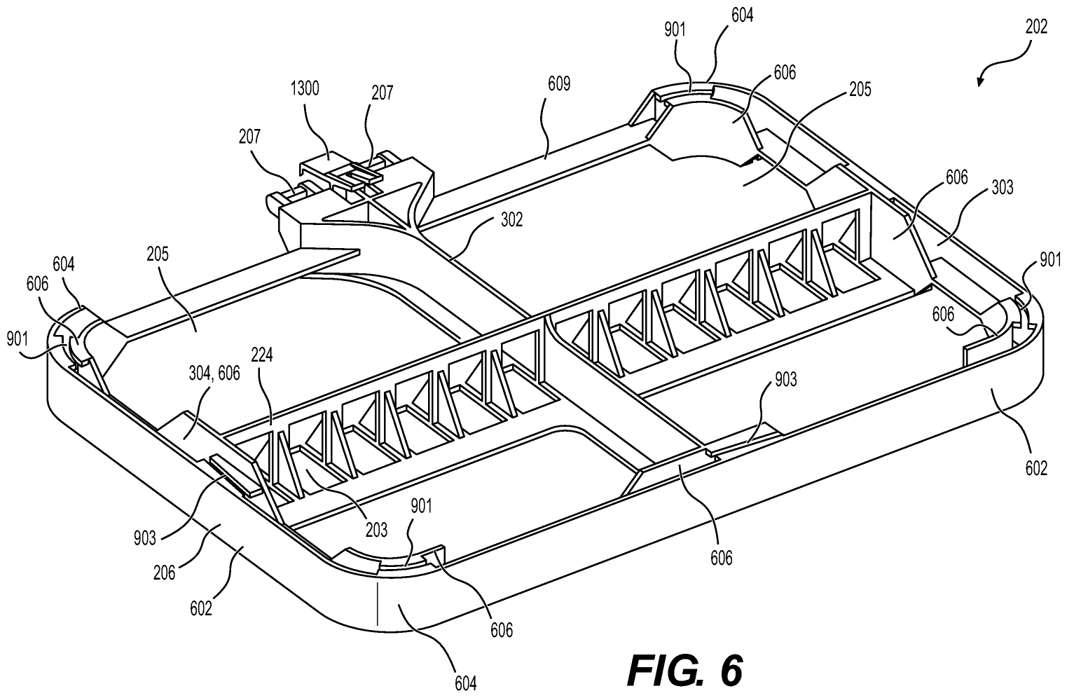

FIG. 6 is a perspective view of the adapter tray 202 that shows more detail regarding the cable channel 303 of the adapter tray 202. In this example, the perimeter wall 206 includes corner walls 604 and side walls 602. In this example, the inner walls 304 include various inner wall sections 606. The distance between the permitter wall 206 and the inner walls 304 (the width of the cable channel 303) is sized to accommodate the size and number of cables expected to be used in the adapter tray 202.

Referring back to FIG. 1, cables 701 routed through an opening 703 and then below the adapter tray 107. Cables 709 are routed on top of the adapter tray 107, though a channel 705, and then below the adapter tray 107. An absence of cable management below the adapter tray 107 can result in the cables below the adapter tray 107 becoming tangled and difficult to differentiate and reconfigure.

FIG. 2 shows the inner wall sections 606 and the corner walls 604 of the cable channel 303. In embodiments, the adapter tray 202 is rectangular, square, circular, triangular, or other shaped.

FIG. 3 shows the inner wall sections 606 and the corner walls 604 of the cable channel 303. Cable insertion slots 901 are shown between the inner wall sections 606 and the corner walls 604 and are configured to allow cables to be inserted into the cable channel 303. Similarly, cable insertion slots 903 are also provided. Cables are routed around the edges of the adapter tray 202, which is not possible when using the fiber management tray depicted in FIG. 1.

FIGS. 4-6 also show the inner wall sections 606 and the corner walls 604 of the cable channel 303. Also shown are the cable insertion slots 901 and the cable insertion slots 903.

In embodiments, the cable insertion slots 901, 903 are configured to be wide enough to admit a cable or a bundle of cables, but narrow enough and angled enough to inhibit the cables from exiting the cable channel 303 without user manipulation. In embodiments, the cable insertion slots 901, 903 are located at the corners and sides of the rectangular adapter tray 202. In embodiments, cable insertion slots are located around the entire perimeter of the adapter tray 202.

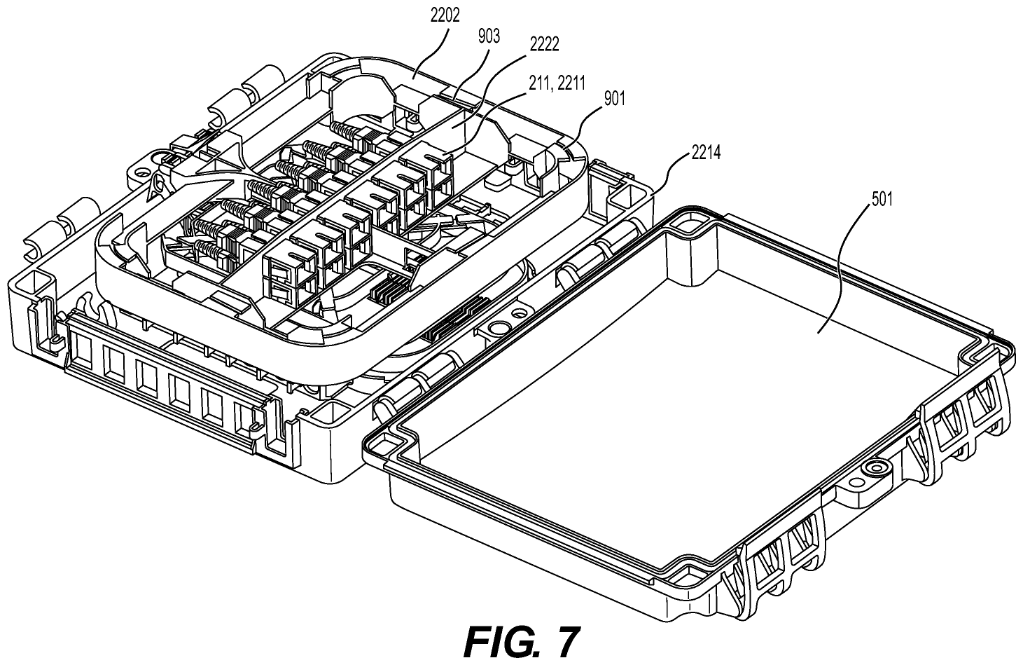

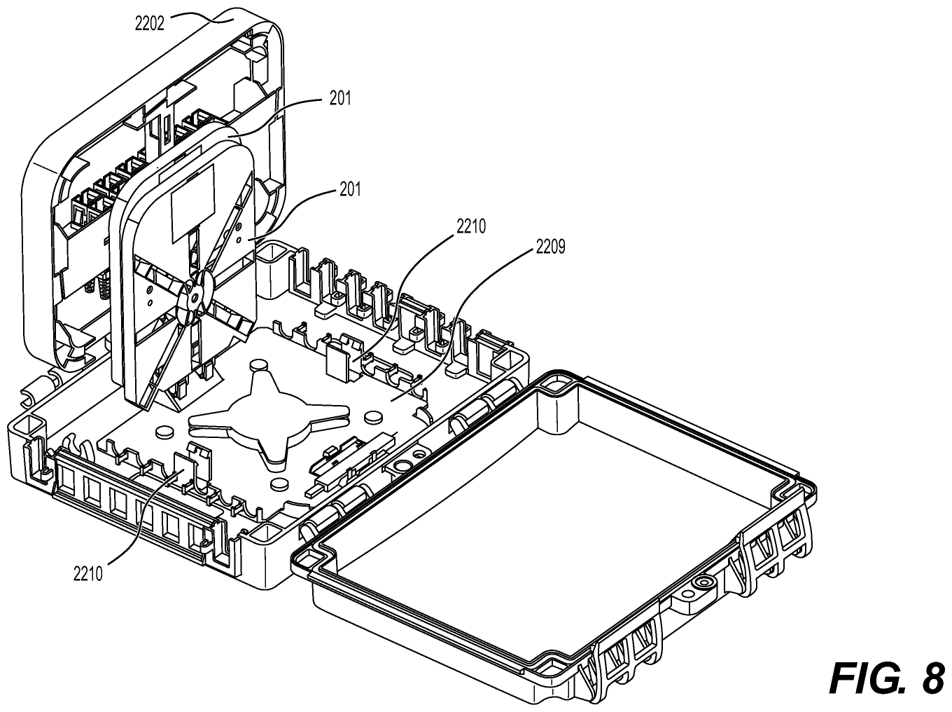

FIGS. 7-10 show an example of an adapter tray 2202 that is similar to the adapter tray 202 but is configured to receive two rows of adapters 211 and/or a row of double adapters 2211. In the example shown in FIG. 8, a base plate/splitter tray 2209 has securing features 2210 similar to the securing features 210 of the base plate/splitter tray 209. In the example shown in FIG. 8, the securing features 2210 are taller than the securing features 210 to accommodate a taller adapter tray 2202. This example, the adapter tray 2202 is taller than the adapter tray 202 in order to better accommodate the double height adapters 2211 (or two rows of the adapters 211). The taller adapter tray 2202 also provides a taller cable channel 303 that can receive more cables than the shorter cable channel 303 of the adapter tray 202. In other embodiments, the adapter tray 202 is configured to receive the double adapters 2211 or two rows of adapters 211 by, for example, having a taller fence 2222.

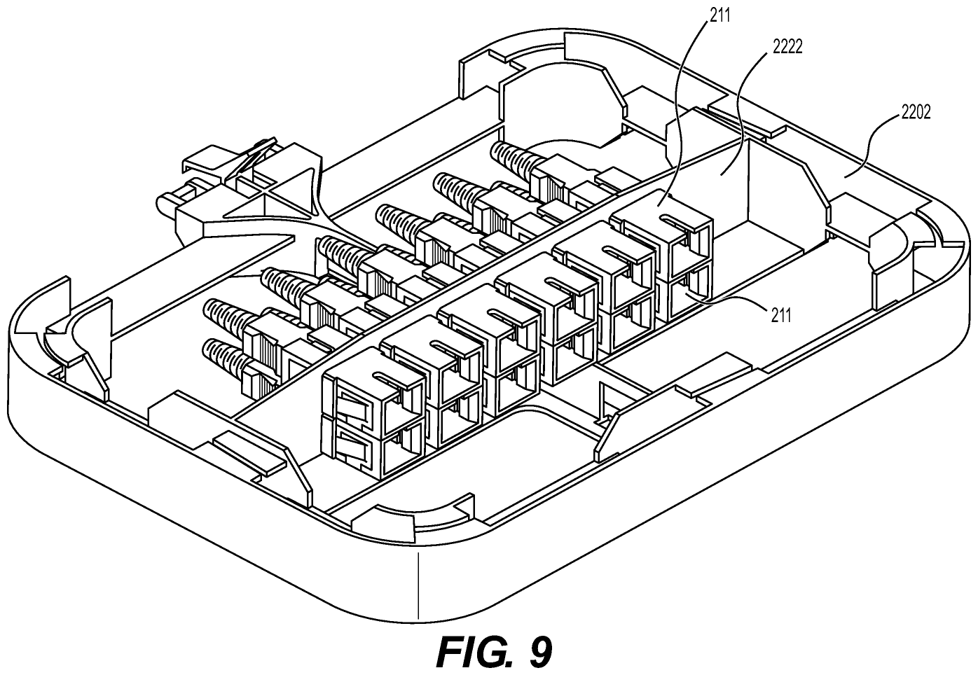

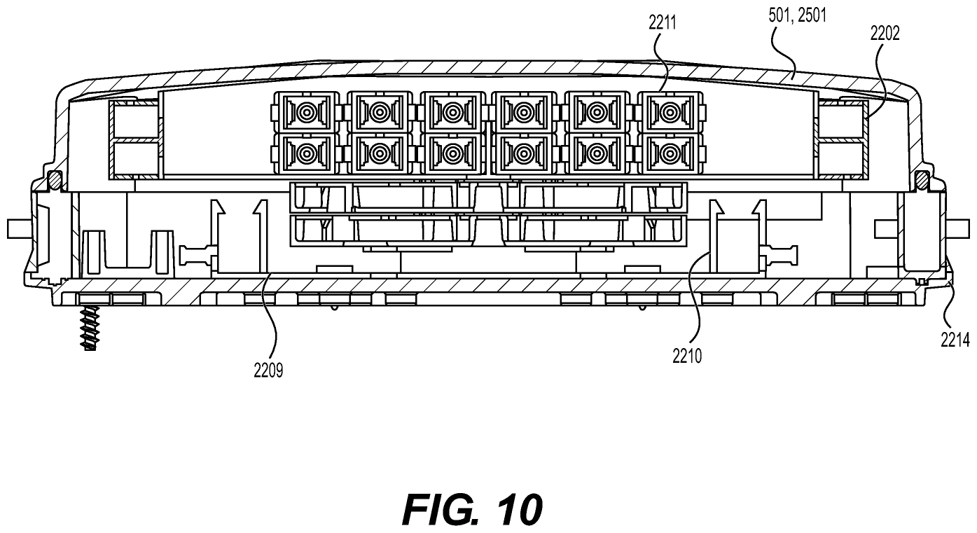

FIG. 9 shows the adapter tray 2202 with two rows of the adapters 211. FIG. 10 is a sectional view of the enclosure 2214, the cover 501, 2501, the base plate/splitter tray 2209, and the adapter tray 2202.

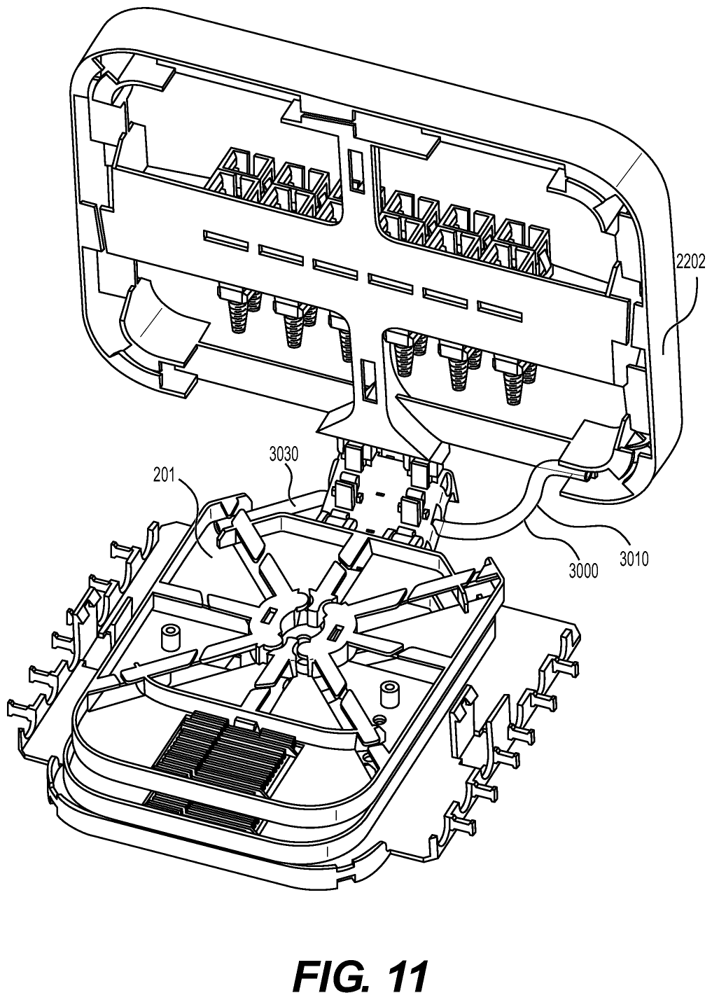

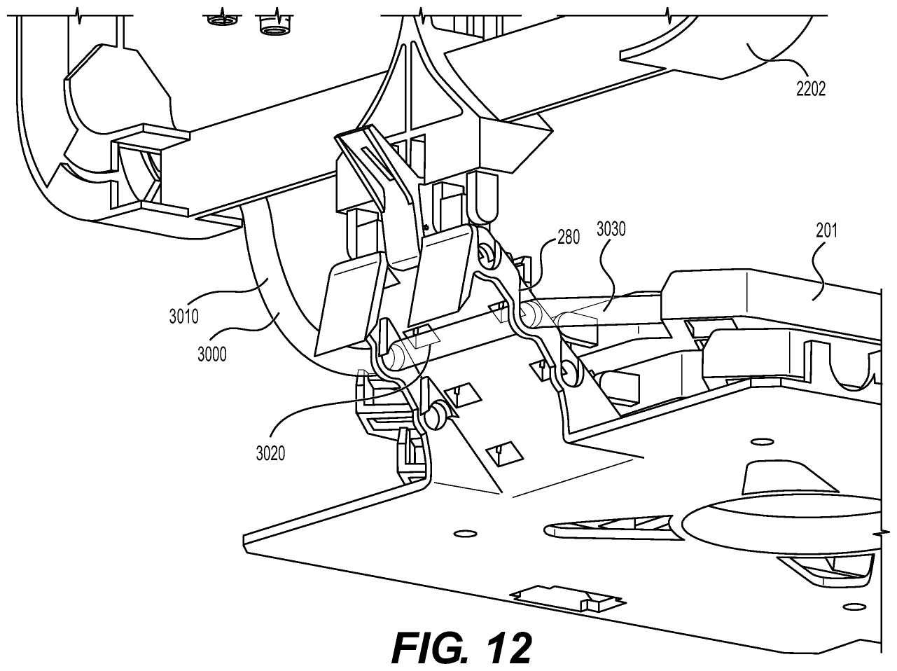

FIGS. 11 and 12 show an example of transport tubing 3000 that extends from the adapter tray 2202 to one or more of the splice trays 201. The transport tubing 300 provides protection for one or more optical fibers, for example, that extend between the adapter tray(s) 202, 2202 and the splice tray(s) 201. In this example, the transport tubing 3000 is a single piece of tubing that includes a first section 3010 that extends from the adapter tray 2202 to a mounting extension 280 (described in more detail below), a third section 3030 that extends from the mounting extension 280 to the splice tray 201, and a second section 3020 that connects the first section 3010 to the third section 3030. Other examples have multiple separate sections and/or are routed differently between the adapter tray(s) 202, 2202 and the splice tray(s) 201 and/or other devices or locations.

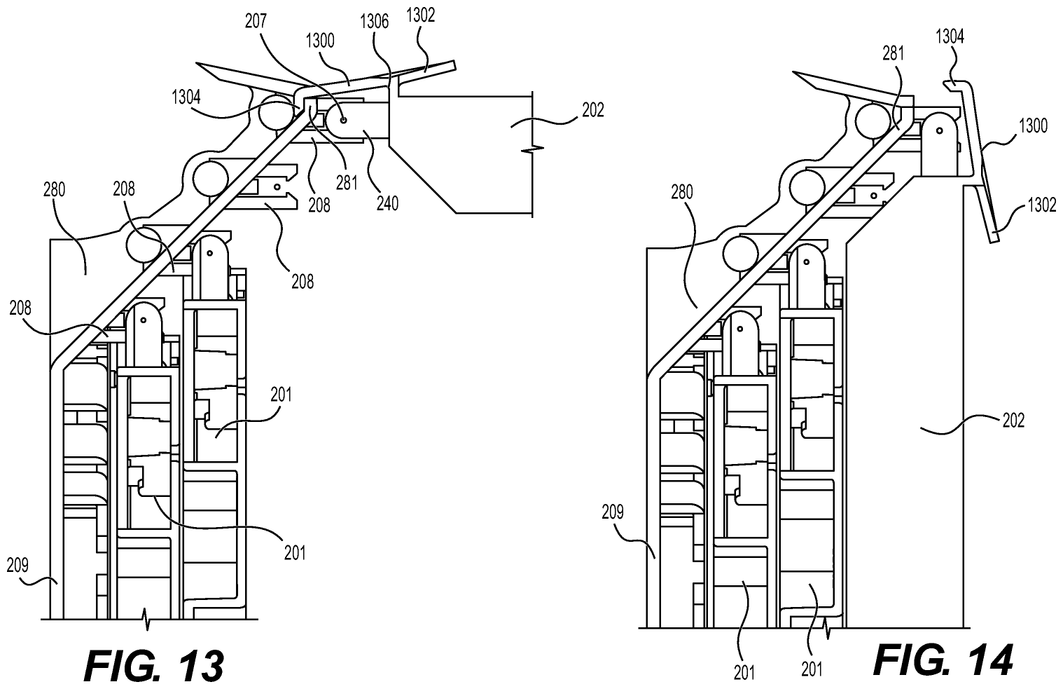

FIGS. 13-18 show an exemplary adapter tray clip 1300 in accordance with various aspects of the disclosure. FIG. 13 shows the adapter tray 202 attached to one of the receiving portions 208 of the base plate 209. In this embodiment, the receiving portion 208 is configured as an extension from an angular mounting extension 280 that extends from the base plate 209. As shown in FIG. 13, one or more of the adapter trays 202 and/or one or more of the splice trays 201 can be mounted to the base plate 209. In this example, the adapter tray 202 is attached to the receiving portion 208 by the hinge pins 207 (each of which extends between two walls 240) being received in the receiving portions 208. FIG. 13 shows the adapter tray 202 being held in an upper or open position by the adapter tray clip 1300. In this example, the adapter tray clip 1300 has an engagement portion (in this example, a hook or latch) 1304 that extends over a ledge 281 formed at the end of the mounting extension 280 of the base plate 209. In embodiments, when the adapter tray 202 is pressed into the open position by the user, the latch 1304 resiliently deforms sufficiently to slide over the ledge 281 and then drop into engagement after passing the ledge 281, holding the adapter tray 202 in the open position. To disengage the latch 1304 from the ledge 281, a user presses on a finger (or lever) 1302 located at an end of the adapter tray clip 1300 opposite to the latch 1304. A fulcrum 1306 of the adapter tray clip 1300 is located between the lever 1302 and the latch 1304. The adapter tray clip 1300 pivots about the fulcrum 1306. By holding the adapter tray 202 in the open position, the adapter tray clip 1300 allows the user to easily access the splice trays 201 and/or perform operations on the adapter tray 202 that require (or are made easier by) accessing the underside or both sides of the adapter tray 202.

FIG. 14 shows the adapter tray 202 in a lower or closed position in which the adapter tray clip 1300 is not engaged with the base plate 209. More particularly, FIG. 14 shows the latch 1304 in a disengaged position in which the latch 1304 is not engaged with the ledge 281.

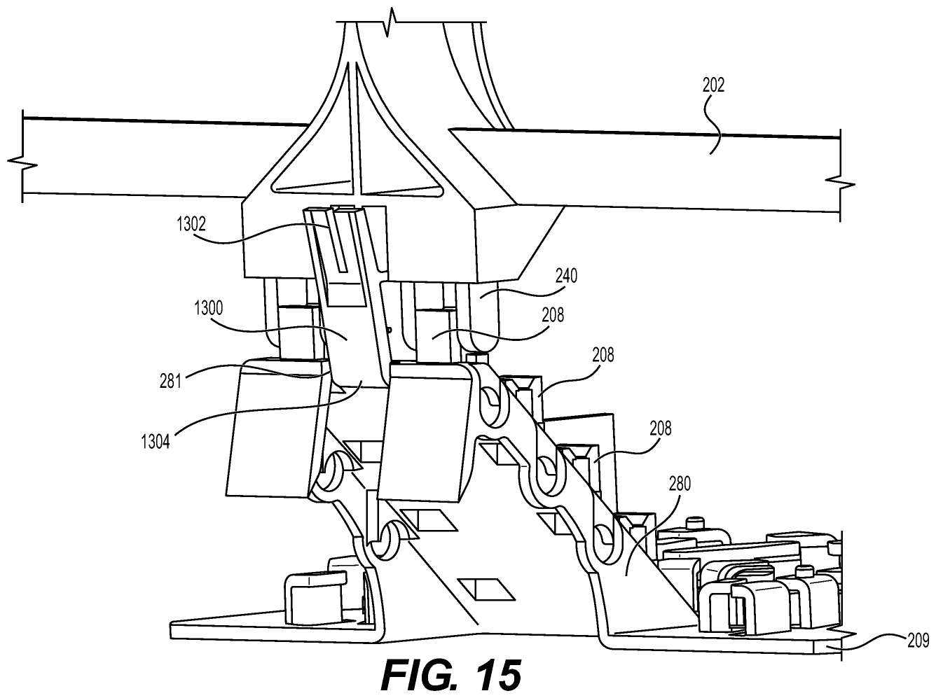

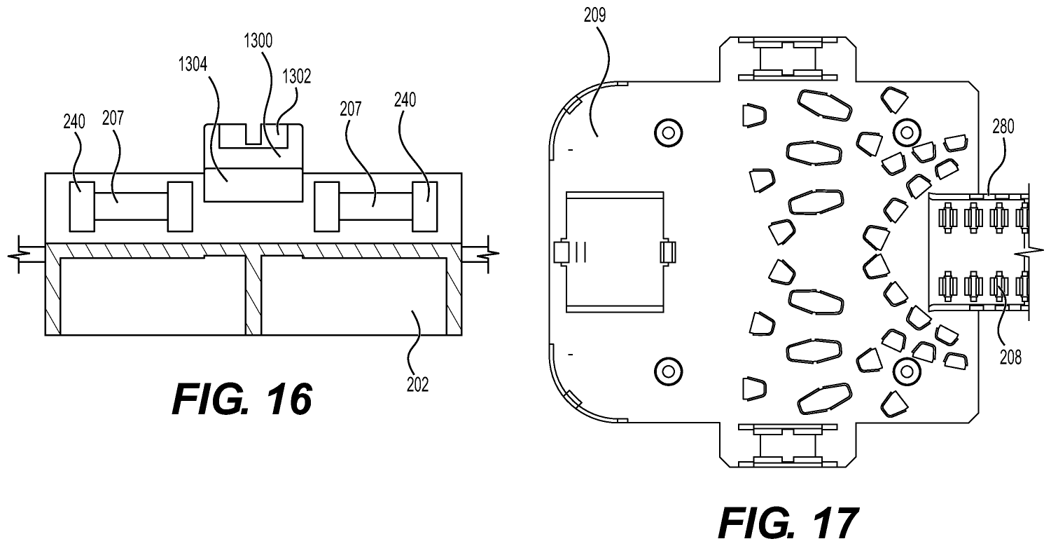

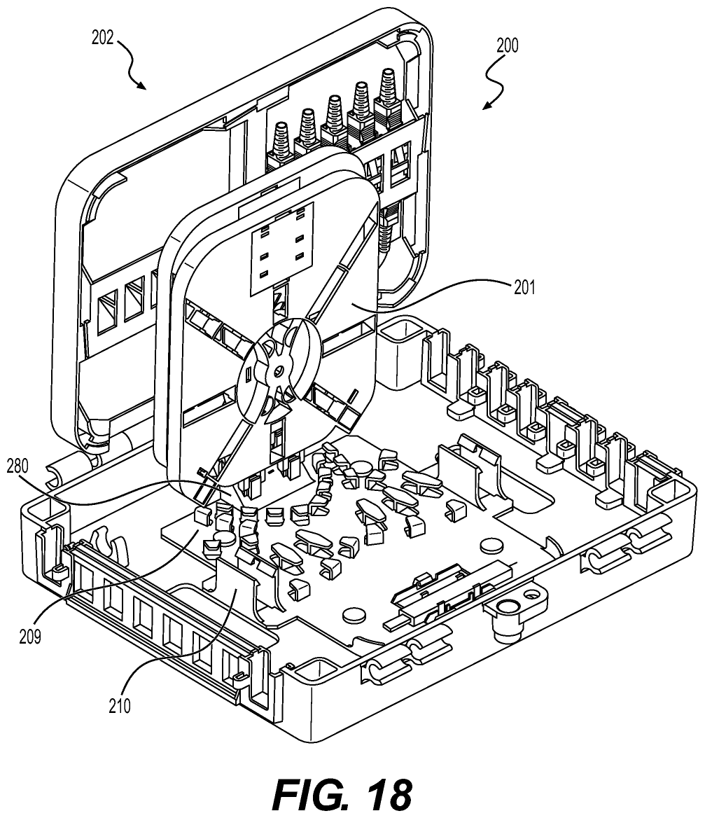

FIG. 15 shows a partial view of the adapter tray 202 being held in the open position by the latch 1304 of the adapter tray clip 1300 engaging the ledge 281 of the base plate 209. The interaction between the hinge pins 207 (not shown) of the adapter tray 202 and the receiving portions 208 of the base plate 209 can be seen in FIG. 15. FIG. 16 is a top view of the adapter tray 202 showing the hinge pins 207 and the latch 1034, and the finger 1302 of the adapter tray clip 1300. FIG. 17 is a top view of the base plate 209 showing the mounting extension 280 and the receiving portions 208. FIG. 18 shows the adapter tray 202 being held in the open position and the splice trays 201 in the open position.

While the embodiments described show one ledge 281 that is located in a position that is configured to receive the latch 1304 of the adapter tray 202 mounted in the upper or outer most position, other embodiments include additional ledges corresponding to other mounting positions such that one or more trays in positions other than the upper most position can be clipped open.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A cable adapter tray configured to provide enhanced cable management, comprising:
an adapter mounting portion that is configured to receive an optical fiber cable adapter that is configured to receive a cable connector attached to a cable;
a perimeter portion that is configured to extend around the adapter mounting portion;
an inner cable retention portion that is configured to be positioned between the perimeter portion and the adapter mounting portion;
a cable receiving portion separator portion that is configured to extend between the perimeter portion and the inner cable retention portion;
wherein the cable receiving portion separator portion is configured to separate an area between the perimeter portion and the inner cable retention portion into an upper cable receiving portion and a lower cable receiving portion;
wherein the upper cable receiving portion is configured to receive and retain one or more first cables;
wherein the lower cable receiving portion is configured to receive and retain one or more second cables; and
wherein the upper cable receiving portion is structurally configured to provide a first cable routing path along a first side of the cable adapter tray and the lower cable receiving portion is structurally configured to provide a second cable routing path along an opposite second side of the cable adapter tray so as to enhance organization of cables in the cable adapter tray by providing two separate routing options for routing cables in the cable adapter tray.

2. The cable adapter tray of claim 1, wherein the upper cable receiving portion is a channel, and the lower cable receiving portion is a channel.

3. The cable adapter tray of claim 1, wherein the adapter tray includes a hinge portion that is configured to be pivotally coupled with a receiving portion of a base portion such that the cable adapter tray is configured to pivot between an open position and a closed position.

4. The cable adapter tray of claim 1, wherein the cable adapter tray further comprises an upper cable receiving portion cable retaining portion that is configured to extend between the perimeter portion and the inner cable retention portion and over the upper cable receiving portion.

5. The cable adapter tray of claim 4, wherein the upper cable receiving portion cable retaining portion comprises an upper cable receiving portion access opening.

6. The cable adapter tray of claim 5, wherein the upper cable receiving portion access opening is configured to allow a cable to be inserted into the upper cable receiving portion.

7. The cable adapter tray of claim 6, wherein the cable adapter tray further comprises a lower cable receiving portion cable retaining portion that is configured to extend between the perimeter portion and the inner cable retention portion and over the lower cable receiving portion, the lower cable channel receiving portion retaining portion comprises a lower cable receiving portion access opening configured to allow a cable to be inserted into the lower cable receiving portion.

8. The cable adapter tray of claim 5, wherein the cable adapter tray further comprises a lower cable receiving portion cable retaining portion that is configured to extend between the perimeter portion and the inner cable retention portion and over the lower cable receiving portion, and the lower cable receiving portion cable retaining portion comprises a lower cable receiving portion access opening.

9. The cable adapter tray of claim 4, wherein the cable adapter tray further comprises a lower cable receiving portion cable retaining portion that is configured to extend between the perimeter portion and the inner cable retention portion and over the lower cable receiving portion.

10. The cable adapter tray of claim 1, wherein the inner cable retention portion is parallel to the perimeter portion at a majority of locations of the inner cable retention portion.

11. The cable adapter tray of claim 1, wherein the inner cable retention portion is parallel to the perimeter portion at all locations of the inner cable retention portion.

12. An adapter management device configured to provide enhanced cable management, comprising:
an adapter receiving portion;
a perimeter portion;
an inner cable retention portion that is configured to be positioned between the perimeter portion and the adapter receiving portion;
a cable receiving portion separator portion that is configured to extend between the perimeter portion and the inner cable retention portion and separate an area between the perimeter portion and the inner cable retention portion into a first cable receiving portion and a second cable receiving portion;
wherein the first cable receiving portion is configured to receive and retain one or more first cables;
wherein the second cable receiving portion is configured to receive and retain one or more second cables; and
wherein the first cable receiving portion is structurally configured to provide a first cable routing path along a first side of the adapter management device and the second cable receiving portion is structurally configured to provide a second cable routing path along an opposite second side of the adapter management device so as to enhance organization of cables in the adapter management device by providing two separate routing options for routing cables in the adapter management device.

13. The adapter management device of claim 12, wherein the upper cable receiving portion is a channel, and the lower cable receiving portion is a channel.

14. The adapter management device of claim 12, wherein the adapter receiving portion is configured to receive an optical fiber cable adapter that is configured to receive a cable connector attached to a cable.

15. The adapter management device of claim 12, wherein the perimeter portion is configured to extend around the adapter receiving portion.

16. The adapter management device of claim 12, wherein the adapter management device includes a hinge portion that is configured to be pivotally coupled with a receiving portion of a base portion such that the adapter management device is configured to pivot between an open position and a closed position.

17. The adapter management device of claim 12, wherein the adapter management device further comprises a first cable receiving portion cable retaining portion that is configured to extend between the perimeter portion and the inner cable retention portion and over the first cable receiving portion.

18. The adapter management device of claim 17, wherein the first cable receiving portion cable retaining portion comprises a first cable receiving portion access opening.

19. The adapter management device of claim 18, wherein the first cable receiving portion access opening is configured to allow a cable to be inserted into the first cable receiving portion.

20. The adapter management device of claim 19, wherein the adapter management device further comprises a second cable receiving portion cable retaining portion that is configured to extend between the perimeter portion and the inner cable retention portion and over the second cable receiving portion, and the second cable receiving portion cable retaining portion comprises a lower cable receiving portion access opening.

21. The adapter management device of claim 18, wherein the adapter management device further comprises a second cable receiving portion cable retaining portion that is configured to extend between the perimeter portion and the inner cable retention portion and over the second cable receiving portion.

22. The adapter management device of claim 13, wherein the inner cable retention portion is parallel to the perimeter portion at a majority of locations of the inner cable retention portion.

23. An adapter management device, comprising:
an adapter receiving portion;
a perimeter portion;
an inner cable retention portion that is configured to be positioned between the perimeter portion and the adapter receiving portion;
a cable receiving portion separator portion that is configured to extend between at least a portion of the perimeter portion and the inner cable retention portion; and
wherein the cable receiving portion separator portion is structurally configured to provide a first cable routing path and a second cable routing path so as to enhance organization of cables in the adapter management device by providing two separate routing options for routing cables in the adapter management device.

24. The adapter management device of claim 23, wherein the first cable routing path is a channel, and the second cable routing path is a channel.

25. The adapter management device of claim 23, wherein the cable receiving portion separator portion is configured to extend between the perimeter portion and the inner cable retention portion and separate an area between the perimeter portion and the inner cable retention portion into the first cable routing path and the second cable routing path.

26. The adapter management device of claim 25, wherein the first cable routing path is a first cable receiving portion and the second cable routing path is a second cable receiving portion.

27. The adapter management device of claim 26, wherein the first cable receiving portion is configured to receive and retain one or more first cables, and the second cable receiving portion is configured to receive and retain one or more second cables.

28. The adapter management device of claim 27, wherein the adapter management device further comprises a first cable receiving portion cable retaining portion that is configured to extend between the perimeter portion and the inner cable retention portion and over the first cable receiving portion.

29. The adapter management device of claim 28, wherein the first cable receiving portion cable retaining portion comprises a first cable receiving portion access opening that is configured to allow a cable to be inserted into the first cable receiving portion.
